(19) United States
(12) Patent Application Publication
(10) Pub. No.: US 2006/0060648 A1
(43) Pub. Date: Mar. 23, 2006

(54) Method and apparatus for storing and reading medical records from a magnetic card

(76) Inventor: Thomas C. Valenza, Glenshaw, PA (US)

Correspondence Address: JAMES RAY & ASSOCIATES, 2640 PITCAIRN ROAD, MONROEVILLE, PA, 15146, US

(21) Appl. No.: 10/947,630

(22) Filed: Sep. 22, 2004

(51) Int. Cl. G06K 5/00

(52) U.S. Cl. 235/380

(57) ABSTRACT

A method of providing medical personnel with a patient's preselected medical information. The method comprises the steps of providing a card having at least one magnetic strip disposed thereon and embedding the patient's preselected medical information into the at least one magnetic strip disposed on said card.

### FIELD OF THE INVENTION

The present invention relates, in general, to a card, similar to a credit card, with a magnetic strip disposed on the card that can be used to store and read medical records, and more particularly, the present invention relates to a card with a magnetic strip which stores an individual's preselected medical information.

### BACKGROUND OF THE INVENTION

In case of an emergency will your medical records be available in the event you may end up in an emergency room after a car accident, heart attack or other mishap? This is a question that most people should be asking because a persons medical records may help save the persons life. One of the problems is the current archaic system of paper records.

The Federal government recently announced ambitious plans to create a vast new information system for patients and to provide incentives for physicians to adopt electronic records which could improve the quality of care by giving patients and their doctors a complete up to date view of the patients medical history, medications and allergies, but also could help reduce medical errors. However, this may be well down the road considering the speed at which governments operate. And there is an immediate need.

With all of the prescriptions that people in today's society are taking it is very important for medical personnel, be they emergency EMT's with an ambulance or the staff at an hospital's emergency room, to have this information because what is done may affect the patients chances of survival. Since medications are not always compatible with other medications the knowledge of what an individual is taking is very important. People have been told that it is a good idea to keep a list of prescriptions and other medications that they are taking on their person at all times. However, the majority of people do not do this. Thus, it would be advantageous if there were a simple and complete means for an individual to keep a record of his medical information in a convenient means.

### SUMMARY OF THE INVENTION

The present invention provides a method of providing medical personnel with a patient's preselected medical information. The method comprises the steps of providing a storage means for storing such patient's preselected medical information and embedding the patient's preselected medical information into the at least one magnetic strip disposed on said card.

In an alternate embodiment of the invention there is provided an apparatus for storing and reading a patient's preselected medical information. The apparatus comprises a storage means for storing such patient's preselected medical information. There is a first means engageable with the storage means for embedding such preselected medical information on the storage means; and a second means engageable with the storage means for reading the preselected medical information that is stored on such storage means.

### OBJECTS OF THE INVENTION

The primary object of the present invention is to provide a card with a magnetic strip which contains the persons current medication list.

It is also an object of the present invention to provide a card with a magnetic strip which contains the persons current list of allergies and immunizations.

Another object of the present invention to provide a card with a magnetic strip which contains the persons current physicians and specialists.

It is still another object of the present invention to provide a card with a magnetic strip which contains the persons medical and surgical history.

It is yet another object of the present invention to provide a method for use of a card with a magnetic strip in which a patient's medical information is stored.

These and various other objects and advantages of this invention will become apparent after a full reading of the following detailed description, particularly, when read in conjunction with the appended claims.

### BRIEF DESCRIPTION OF THE DRAWINGS

FIG. 1 is a front view of a card resembling a credit card having a magnetic strip on the card according to an embodiment of the invention.

FIG. 2 is a back view of the card as shown in FIG. 1, having a magnetic strip on the back of the card.

FIG. 3 is a front view of a card resembling a credit card having two magnetic strips disposed on the front of the card.

FIG. 4 is a back view of a card resembling a credit card having two magnetic strips on the back of the card.

FIG. 5 is a cut away of a front view of a reader according to an embodiment of the invention.

FIG. 6 is a block diagram showing the steps performed in the method of providing medical personnel with a patient's preselected medical information disposed on a card.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides a method of providing medical personnel with a patient's preselected medical information embedded in a storage means. It is within the scope of the invention that such storage means include a card, similar to a credit card, a key having storage means disposed thereon or any other similar type of storage means. It is presently preferred that such storage means be a card and the following procedure will be described as using a card. However, it must be understood that such procedure could be modified slightly to include the use of other storage means.

Such invention then provides a method of providing medical personnel with a patient's preselected medical information embedded in a card, generally designated 10. Such card has at least one magnetic strip 2 disposed on the card 10. Such card would ordinarily be made of plastic and would resemble a credit card. Such card 10 has at least one magnetic strip disposed on the card. The method comprises the steps of providing the card 10 which has at least one magnetic strip 2 disposed thereon; and then embedding the patient's preselected medical information into the magnetic strip 2 disposed on the card 10.

The method further includes the additional steps of having the patient give the card 10 having the patient's preselected medical information embedded in the magnetic strip 2 to a predetermined medical technician, then having the medical technician swipe the card in a reader 20. Another step includes providing a print out of the predetermined medical information stored on the card 10 that was swiped in the previous step, this is followed by determining at least one of a treatment to be administered to the patient or what medications should be given.

This is followed by updating the patient's preselected medical information embedded in the magnetic strip 2 based on the determination made by the medical personnel in the previous step. It is important that medical information be updated on the card 10 so that all of the latest information will be included when the card 10 is used again. The next step involves returning the card 10 having said patient's updated medical information embedded thereon to the patient when said patient is discharged from care. It should be noted that within the context of the invention that “discharged from care” could be just leaving the doctor's office after a routine visit or it could be being discharged from the emergency room or the hospital or wherever the patient is being treated.

Thus, the method as described above means that all patients would carry a card 10 that will be like a credit card which contains all of the patients medical information such as height, weight, age, prescriptions presently being used by the patient, allergic reactions to certain medications, blood pressure, previous operations, any health problems and all of the information that the doctor, such as the primary care physician, normally enters in the patients folder. All of this information can be stored in the magnetic strip 2 that is disposed on the card 10.

When the card 10 is swiped by a card reader 20 on presentation to medical personnel a template would appear on the computer screen that could be updated, stored, printed, and then attached to the chart with the patient's file. This information would then be available to the medical personnel that would be dealing with the patient. This could be just a normal office visit to a primary care physician, a visit to a specialist for whatever reason, where the patient may be involved in an accident in which emergency personnel would have to treat the patient, or going to the hospital for any reason. In the case of an accident or in the emergency room of a hospital the availability of this information is especially important if the event the patient is incoherent or unconscious. Having this information could prevent the emergency personnel from administering the wrong medication which could possibly endanger the person's life.

One other advantage of the card system would be that the patient does not have to bring a bag of medicine bottles to the doctor's office. Nor would the treating medical personnel have to rely upon the patient's memory for medications the patient is presently taking, current health problems, dates of previous hospitalizations or the reasons for such hospitalizations. It would thereby minimize the potential for medication errors or drug interactions if the treating medical personnel have an accurate list of medications and knowledge of the patients medical history.

The present method encompasses the fact that such reading and embedding equipment be available at all doctor's offices, at hospitals and with all emergency personnel such as EMT's. The usefulness of the present invention also depends upon a patient carrying the card with him at all times; however, since the card is similar in size and shape to a credit card and since most people carry at least one credit card the likelihood that a person will carry the card is increased. The card could be carried right with the patients insurance card so it would always be with the patient and be available for immediate use.

In an alternate embodiment of the invention there is provided an apparatus for storing and reading a patient's preselected medical information. The apparatus comprises a storage means for storing such patient's preselected medical information. As discussed previously it is preferred that such storage means be a card; however, it is within the scope of the invention that such storage means be other than the card. The description of the apparatus will focus on the card 10 having at least one magnetic strip 2 disposed thereon.

There is a first means 30 for embedding such preselected medical information on the magnetic strip 2 that is disposed on the card 10, and a second means 20 for reading such preselected medical information that is stored on the magnetic strip 2 or strips 2 disposed on the card 10.

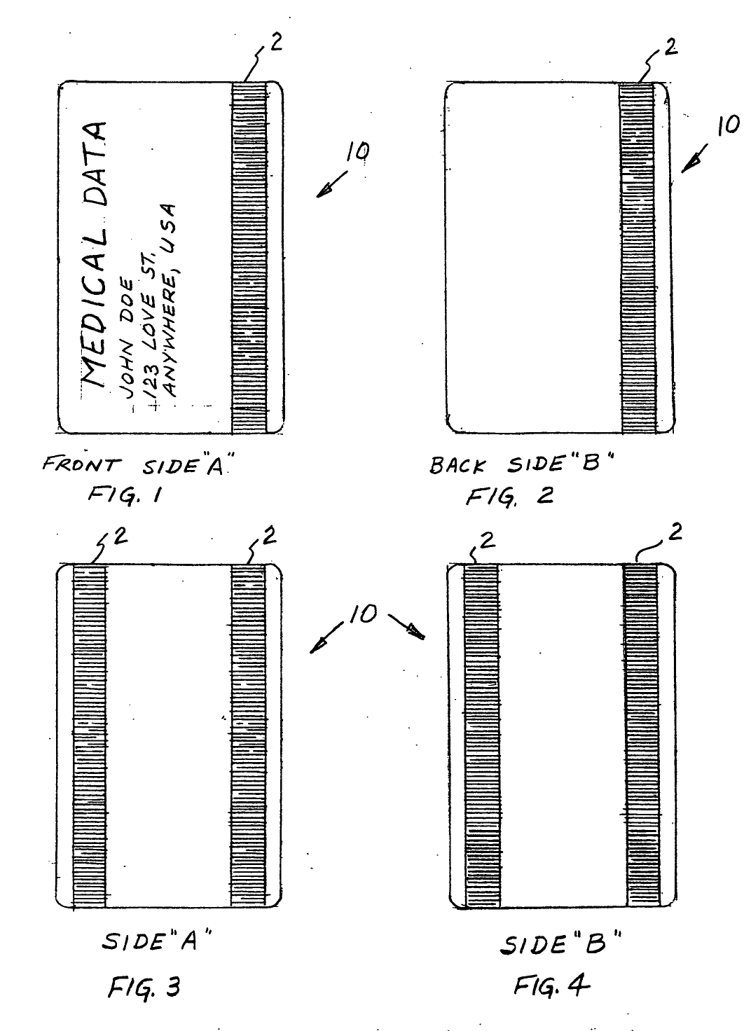

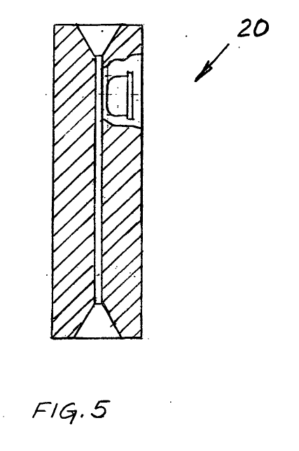

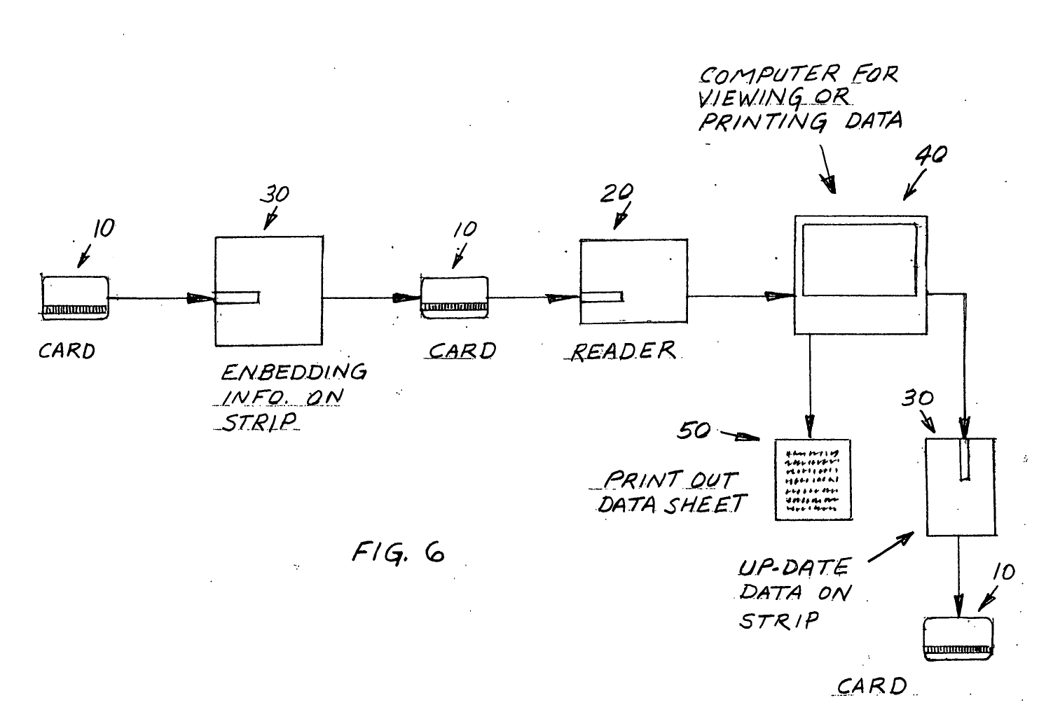

Illustrated in FIGS. 1-4 is an alternate embodiment of the invention in which such card has a plurality of magnetic strips disposed on the card. The card 10 may have one, two, three or four magnetic strips 2 disposed the card 10. The card 10 may have one magnetic strip on the back, or one magnetic strip on the front or both. The card may also have two magnetic strips on the back with one on the front or vice versa. FIGS. 3 shows the card with two magnetic strips 2 provided on the back of the card 10 while FIG. 4 shows the opposite side of card 10 and with two magnetic strips 2 on the front of the card 10.

In one aspect of the invention the plurality of magnetic strips 2 on card 10 in which similar data is disposed on each of the various strips and is used to simplify the reading of the card.

The card 10 with four magnetic strips is designed so that the medical information can be obtained from the card 10 regardless of the position the card 10 is fed into the reader 20. This could be important when time is critical and can avoid the problem of inserting the card 10 in the reader 20 in the wrong position and then having to reinsert the card 10 so that the magnetic strip 2 is positioned correctly.

In another aspect of the invention the card with the multiple strips 2 is designed so that the individual magnetic strips 2 are used to include different information. An example of this would be where one magnetic strip may be used to include all medications that are presently prescribed for the patient as well as any allergic reactions the patient may have to some medications. Another magnetic strip could be used to include all medical information that would relate to the care of the patient's primary care physician, while another magnetic strip would be used for all of the medical information relating to specialists that are treating such patient.

FIG. 6 is a block diagram which shows the steps in the method for providing medical personnel with a patient's preselected medical information embedded in at least one magnetic strip 2 disposed on a card 10. A patient is given a card 10 and the preselected medical information is inputted and the data embedded 30 in the card by generally well known practices. This information will include at least one of such data as current medications, allergies, immunizations, current doctors, specialists, medical and surgical history, and results of lab tests or any other pertinent medical data for that patient.

The patient then retains the card and is instructed to carry the card with him at all times. When the patient visits a doctor, goes to the hospital, sees a specialist or any other medical personnel, the patient presents the card to the medical personnel.

The medical personnel swipe the card in a reader 20. The data on the card is shown on a template on a computer screen 40. The data can be printed out on a print out sheet 50 and given to the medical person treating the patient so that all of the patient's information is at the fingertips of the treating medical person. The patient receives whatever treatment may be necessary and is then released. The release may be just leaving a doctor's office, leaving an emergency room, being discharged from the hospital or whatever. Before the patient is discharged; however, the new data recording any new medications or treatment received will be inputted and embedded 30 on the magnetic strip and the card 10 is returned to the patient with all of the updated information recorded on his card.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

1. A method of providing medical personnel with a patient's preselected medical information, said method comprising the steps of:
(a) providing a storage means for storing said patient's preselected medical information thereon;
(b) embedding said patient's preselected medical information into said storage means;
(c) giving said storage means having said patient's preselected medical information embedded therein to a predetermined medical technician;
(d) having said predetermined medical technician access said storage means;
(e) providing a print out of said predetermined medical information accessed in step (d);
(f) determining at least one of a treatment to be administered to said patient and what medications should be given based on said print out of said predetermined medical information printed in step (e);
(g) updating said patient's preselected medical information embedded in said storage means based on step (f); and
(h) returning said storage means having said patient's preselected medical information embedded therein and updated in step (g) to said patient when said patient is discharged from care.

2. (canceled)

3. A method of providing medical personnel with a patient's preselected medical information, according to claim 1, wherein said step of embedding said patient's medical information includes embedding said patient's medical information on a card having at least one magnetic strip disposed thereon.

4. (canceled)

5. A method of providing medical personnel with a patient's preselected medical information, according to claim 3, wherein said method includes the additional step of embedding said patient's preselected medical information on a predetermined plurality of magnetic strips.

6. A method of providing medical personnel with a patient's preselected medical information, according to claim 5, wherein said method includes the additional step of embedding said patient's preselected medical information on two magnetic strips.

7. A method of providing medical personnel with a patient's preselected medical information, according to claim 5, wherein said method includes the additional step of embedding said patient's preselected medical information on four magnetic strips.

8. A method of providing medical personnel with a patient's preselected medical information, according to claim 3, wherein said preselected medical information embedded in step (b) includes at least one of current medications, allergies, immunizations, current doctors, specialists, medical and surgical history, and results of lab tests.

9. A method of providing medical personnel with a patient's preselected medical information, according to claim 8, wherein said preselected medical information embedded in step (b) includes current medications, allergies and medical and surgical history.

10. An apparatus for storing and reading a patient's preselected medical information, said apparatus comprising:
(a) a storage means having a predetermined shape for storing such patient's preselected medical information;
(b) a first means engageable with said storage means for embedding such preselected medical information in said storage means;
(c) a computer engageable with said storage means for reading said preselected medical information stored in said storage means; and
(d) a printer connected to said computer for providing a hard copy.

11-13. (canceled)

14. The apparatus, according to claim 10, wherein said storage means is a card having at least one magnetic strip disposed thereon.

15. The apparatus, according to claim 14, wherein said predetermined shape is substantially rectangular.

16. The apparatus, according to claim 14, wherein said preselected medical information for a patient includes at least one of current medications, allergies, immunizations, current doctors, specialists, medical and surgical history, and results of lab tests.

17. The apparatus, according to claim 16, wherein said preselected medical information for a patient includes current medications, allergies and medical and surgical history.

18. The apparatus, according to claim 14, wherein said preselected medical information for a patient is embedded onto a predetermined plurality of magnetic strips.

19. The apparatus, according to claim 18, wherein said preselected medical information for a patient is embedded onto two magnetic strips.

20. The apparatus, according to claim 18, wherein said preselected medical information for a patient is embedded onto four magnetic strips.

21. The apparatus, according to claim 14, wherein said preselected medical information embedded on said at least one magnetic strip includes all medications currently prescribed for such patient.

22. The apparatus, according to claim 21, wherein said preselected medical information embedded on another of said at least one magnetic strip includes all information relating to a primary care physician.

23. The apparatus, according to claim 21, wherein said preselected medical information embedded on another of said at least one magnetic strip includes all information relating to specialists that are treating such patient.
